(19) United States
(12) Patent Application Publication
(10) Pub. No.: US 2003/0188134 A1
(43) Pub. Date: Oct. 2, 2003

(54) Combined addition/subtraction instruction with a flexible and dynamic source selection mechanism

(75) Inventor: Gad Sheaffer, Haifa (IL)

Correspondence Address: KENYON & KENYON, 1500 K STREET, N.W., SUITE 700, WASHINGTON, DC, 20005, US

(73) Assignee: INTEL CORPORATION

(21) Appl. No.: 10/107,258

(22) Filed: Mar. 28, 2002

(51) Int. Cl. G06F 9/00

(52) U.S. Cl. 712/221

(57) ABSTRACT

The present invention relates to a method and system for providing a combined addition/subtraction instruction with a flexible and dynamic source selection mechanism. Specifically, a method can select a plurality of source operands from a plurality of operands, and set a polarity of each of the plurality of source operands to negative, if a value associated with the source operand is set to require negation of the source operand. The method also can add selected pairs of the plurality of source operands in predetermined orders to obtain a plurality of addition results and subtract the selected pairs of the plurality of source operands in the predetermined orders to obtain a plurality of subtraction results. The method further can output the plurality of addition results and the plurality of subtraction results.

### FIELD OF THE INVENTION

The present invention relates to processor architectures and instruction sets, and in particular, to processor architectures with instruction sets that provide a combined addition/subtraction instruction with a flexible and dynamic source selection mechanism.

### BACKGROUND

In modern processors execution of instructions occurs, in general, in the following sequential order: the processor reads an instruction, a decoder in the processor decodes the instruction, and, then, the processor executes the instruction. In older processors the clock speed of the processor was generally slow enough that the reading, decoding and executing of each instruction could occur in a single clock cycle. However, modern microprocessors have improved performance by going to shorter clock cycles (that is, higher frequencies). These shorter clock cycles tend to make instructions require multiple, smaller sub-actions that can fit into the cycle time. Executing many such sub-actions in parallel, as in a pipelined and/or super-scalar processor, can improve performance even further. For example, although the cycle time of a present-day processor is determined by a number of factors, the cycle time is, generally, determined by the number of gate inversions that need to be preformed during a single cycle. Ideally, the execute stage determines the cycle time. However, in reality, this is not always the case. With the desire to operate at high frequency, the execute stage can be performed across more than one cycle, since it is an activity that can be pipelined. In a large number of workloads the added latency caused by the additional cycle(s) has only a small impact on processor performance. The ultimate goal of many systems is to be able to complete the execution of as many instructions as quickly and as efficiently as possible without adversely impacting the cycle time of the processor.

One way to increase the number of instructions, or equivalent instructions, that can be executed is to create a single instruction that can perform work that currently can only be accomplished by using multiple instructions without causing any timing problems during the execute phase. An instruction of this type can be especially effective in performing addition and/or subtraction instructions with a flexible and dynamic source selection mechanism both with and without accumulation of the results of the additions and subtractions.

### BRIEF DESCRIPTION OF THE DRAWINGS

FIG. 1 is a block diagram of a computer system that includes an architectural state including one or more processors, registers and memory, in accordance with an embodiment of the present invention.

FIG. 2 is an exemplary structure of a processing core of the computer of FIG. 1 having a super-scalar architecture and/or Very Long Instruction Word (VLIW) architecture with multiple 3:1 adders implemented in two consecutive execute stages, in accordance with an embodiment of the present invention.

FIG. 3 is a top-level flow diagram of a method for providing an accumulatable combined addition/subtraction instruction with a flexible and dynamic source selection mechanism in a processor, in accordance with an embodiment of the present invention.

FIG. 4 is a detailed flow diagram of a method for providing an accumulatable combined addition/subtraction instruction with a flexible and dynamic source selection mechanism in a processor, in accordance with an embodiment of the present invention.

### DETAILED DESCRIPTION

In accordance with an embodiment of the present invention, a combined addition/subtraction instruction with a flexible and dynamic source selection mechanism instruction having an accumulation option may be implemented to execute in two (2) cycles using 3:1 adders to perform the addition/subtraction and conditional accumulation. For example, the combined addition/subtraction instruction may be implemented using a multiplexer in the first pipe stage and a 3:1 adder in the second pipe stage to perform the addition and conditional accumulation. The instruction may operate in a fully pipelined manner (a throughput of one instruction every cycle) and may produce a result after two (2) cycles. The instruction also may use a number of special purpose registers to determine the operand selection and whether an addition or subtraction takes place. The definitions of these special purpose registers are specified below merely to illustrate one possible embodiment of the present invention. Likewise, the instructions also may produce and store multiple flags into one or more of the special purpose registers.

In accordance with an embodiment of the present invention, the basic hardware that may be used by the multi-way addition instructions may include 8-bit and/or 16-bit adders, which may be fitted easily in a single cycle of any processor. This is especially true if the processor on which the instructions are running operates on higher precision data types such as 64-bit integers and floating point numbers. For example, in accordance with an embodiment of the present invention, since the adders are of lower computational complexity, two 3:1, 16-bit adders may be implemented in 2 consecutive execute stages without impacting the cycle time of the processor.

In addition, implementing the whole operation in a single instruction may provide a significant savings in the pipeline front-end instruction supply requirements, since the functionality of multiple instructions may be packed into a single instruction without causing any timing problems during the execute stage.

Similarly, the combined addition/subtraction instruction may provide for significant data reuse, since the input operands are used multiple times in the same instruction. In contrast, to achieve the same functionality using currently available instructions would require, each operand to be read from memory or a register file between three (3) and six (6) times.

The impact of the combined addition/subtraction instruction on overall performance can be significant. For example, in accordance with an embodiment of the present invention, the combined addition/subtraction instruction may reduce the latency required for performing the same operation with current instructions by a factor of up to 10, thus, enabling a significant speedup of applications using this instruction. Specifically, the instruction may enable significant speedup of the execution of a large class of applications, for example, applications for modems, speech and video.

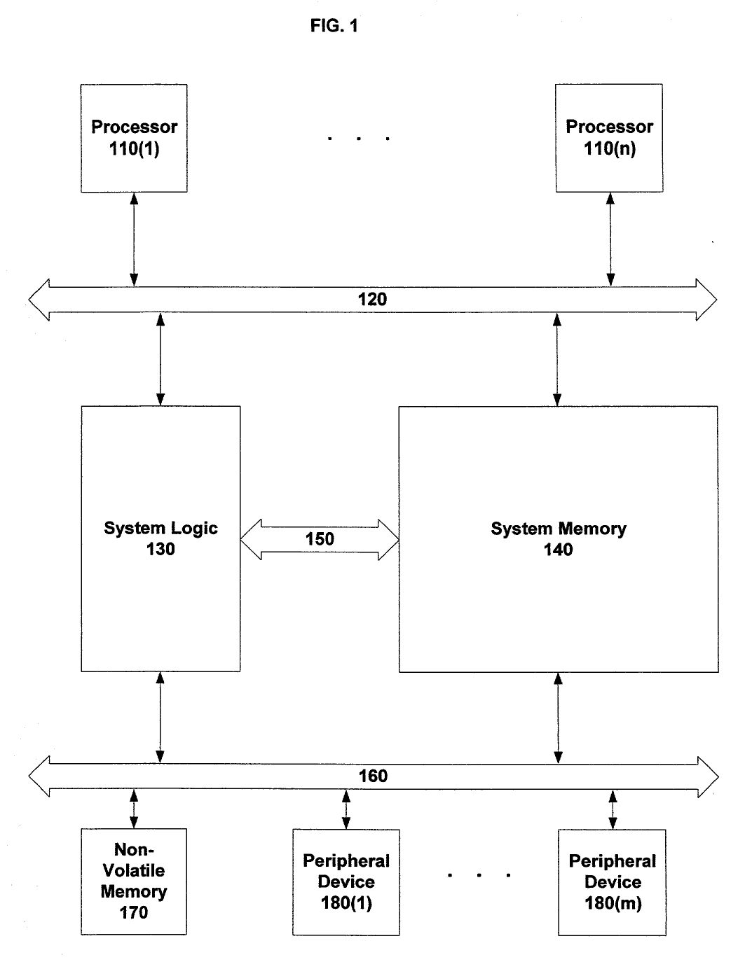

FIG. 1 is a block diagram of a computer system, which includes an architectural state, including one or more processors, registers and memory, in accordance with an embodiment of the present invention. In FIG. 1, a computer system 100 may include one or more processors 110(1)-110(n) coupled to a processor bus 120, which may be coupled to a system logic 130. Each of the one or more processors 110(1)-110(n) may be N-bit processors and may include a decoder (not shown) and one or more N-bit registers (not shown). System logic 130 may be coupled to a system memory 140 through a bus 150 and coupled to a non-volatile memory 170 and one or more peripheral devices 180(l)-180(m) through a peripheral bus 160. Peripheral bus 160 may represent, for example, one or more Peripheral Component Interconnect (PCI) buses, PCI Special Interest Group (SIG) PCI Local Bus Specification, Revision 2.2, published Dec. 18, 1998; industry standard architecture (ISA) buses; Extended ISA (EISA) buses, BCPR Services Inc. EISA Specification, Version 3.12, 1992, published 1992; universal serial bus (USB), USB Specification, Version 1.1, published Sep. 23, 1998; and comparable peripheral buses. Non-volatile memory 170 may be a static memory device such as a read only memory (ROM) or a flash memory. Peripheral devices 180(1)-180(m) may include, for example, a keyboard; a mouse or other pointing devices; mass storage devices such as hard disk drives, compact disc (CD) drives, optical disks, and digital video disc (DVD) drives; displays and the like.

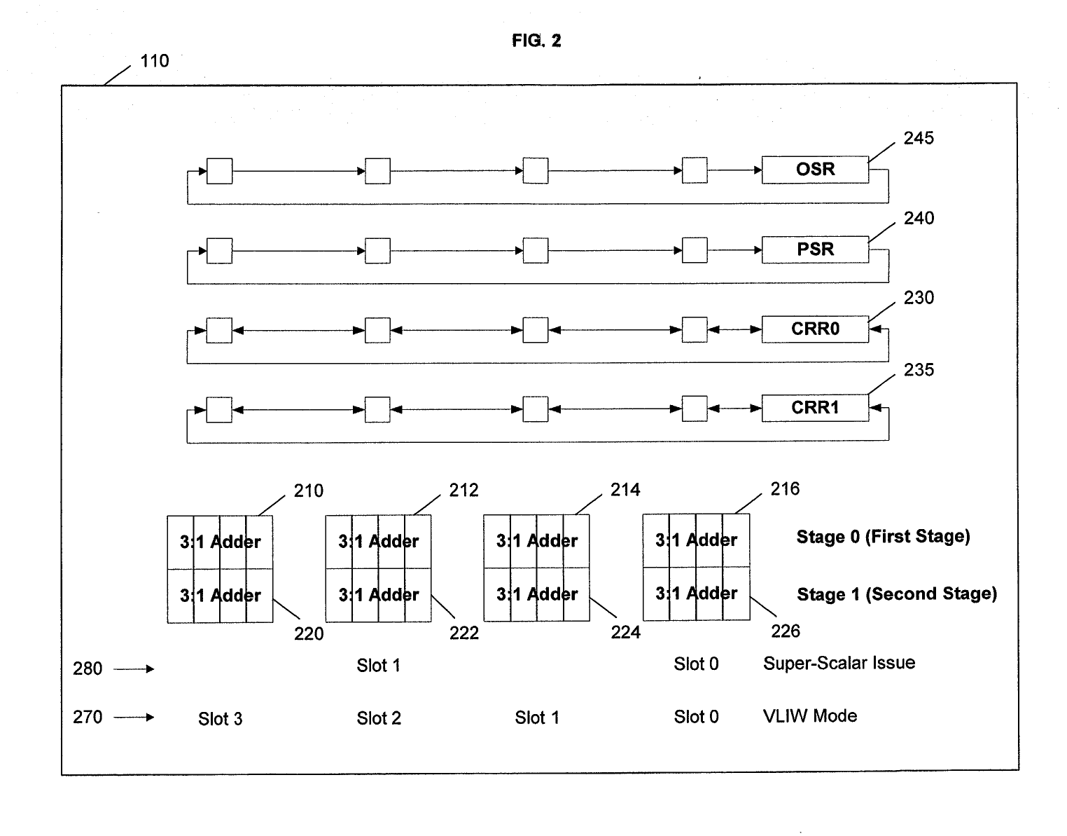

FIG. 2 is an exemplary structure of a processor 110 of the computer of FIG. 1 having a super-scalar architecture and/or Very Long Instruction Word (VLIW) architecture with multiple 3:1 adders 210, 212, 214, 216, 220, 222, 224 and 226 implemented in 2 consecutive execute stages, in accordance with an embodiment of the present invention. Processor 110 also may include several common registers including, for example, Compare Result Registers (CRR0, CRR1) 230, 235, a polarity setting register (PSR) 240 and an Operand Selection Register (OSR) 245. CRR0 230 and CRR1 235 maybe implemented as shift-registers into which all the arithmetic flags generated in a cycle may be shifted. If more than one instruction causing a shift is issued to one of the CRR registers 230, 235 in the same cycle, the CRR registers 230, 235 may be shifted by the sum of the number of bits from each instruction causing the shifts.

For example, all of the instructions consuming the contents of one of CRR0 230 and CRR1 235 may conditionally shift the CRR register used after reading the relevant bits out of the CRR register used. In contrast, all of the instructions modifying the CRR registers may shift the bits of the CRR register used before updating that CRR register. For example, in accordance with an embodiment of the present invention, CRR0 230 may be used for collecting flags generated by the first stage of execution, and for providing flags to the first execution stage. Likewise, CRR1 235 may be used for collecting flags generated by the second stage of execution, and for providing flags to the second execution stage. Using CRR0 230 for the first stage flags and CRR1 235 for the second stage flags enables instructions that are writing to and/or reading from CRR0 230 and/or CRR1 235 to execute back-to-back, that is, in consecutive cycles, without conflict.

In accordance with an embodiment of the present invention, PSR 240 may be implemented as a 32-bit register to control the polarity of the input operands. When the PSR option is set in an instruction, the value of bits in PSR 240 may control the polarity of the input operands in the instruction. Similar to CRR0 230 and CRR1 235, PSR 240 may be conditionally rotated when the bits in the PSR 240 are consumed by instructions that use PSR 240. If more than one instruction is causing PSR 240 to rotate in the same cycle, PSR 240 may be rotated by the sum of the number of bits consumed by the instructions causing the rotation.

In accordance with an embodiment of the present invention, the OSR 245 may be implemented as a 32-bit register to control which item out of a Single Instruction Multiple Data (SIMD) word is to be selected as an input operand for the operation performed by instructions that use this register. OSR 245 also may be conditionally rotated when bits in OSR 245 are consumed by instructions that use it. Using this separation of labor in the definition of instructions enables dispatching instructions consuming and producing PSR 240 and OSR 245 registers to execute back-to-back, that is, in consecutive cycles without conflict.

The combined addition/subtraction instruction may use the control bits from PSR 240 and may use/update bits in CRR0 230 and CRR1 235 based on the issue slot in which the instruction is executed. For example, for an instruction number, I, I may be ε{0,1} in Super-scalar mode, and I may be ε{0,1,2,3} in VLIW mode, where only the adder issue slots 270 and 280 are considered.

In order to minimize the amount of connectivity required to steer bits into and out of the CRR registers 230, 235 and PSR 240, the instructions using PSR 240, CRR0 230 and CRR1 235, in general, may be packed into the lower issue slots. This means that if N such instructions are issued, they would occupy issue slots 0 to N−1. This restriction can be easily enforced in VLIW mode, for example, in the four (4) issue slots 270 in FIG. 2. Unfortunately, in super-scalar mode it can be harder to enforce, and may cause an occasional stall. However, in FIG. 2, in super-scalar mode, if there are only two (2) issue slots 280, it may be easier to provide the required connectivity to enable issuing a single instruction using these registers into slot 1 rather than slot 0.

The combined addition/subtraction instruction may be described in the context of the processor 110 having a Super-Scalar architecture and/or a VLIW architecture. For example, in accordance with an embodiment of the present invention, the data type may be assumed to be 16-bits and the processing core can be assumed to have a 32-bit data path and 32-bit registers. However, it should be clearly understood that this example is merely illustrative and in no way intended to limit the scope of the present invention, since the data type and processing core can be of any other precision either below or above the 16-bit data type:32-bit processor core, for example, 8-bit:32-bit, 16-bit:64-bit, and/or 32-bit:128-bit.

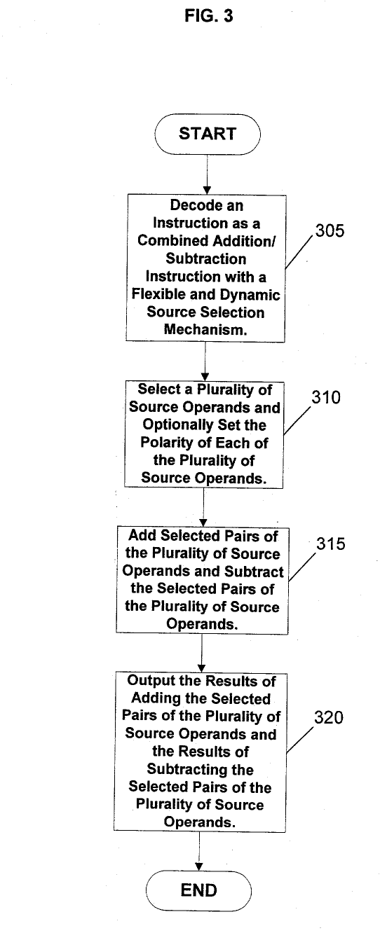

FIG. 3 is a top-level flow diagram of a method for providing a combined addition/subtraction instruction with a flexible and dynamic selection mechanism that may be accumulated in a processor, in accordance with an embodiment of the present invention. In FIG. 3, an instruction may be decoded 305 as an accumulatable combined addition/subtraction instruction with a flexible and dynamic source selection mechanism. A plurality of source operands may be selected 310. Selected pairs of the plurality of source operands may be added 315 in predetermined orders to obtain a plurality of addition results and the selected pairs of the plurality of source operands may be subtracted 315 in the predetermined orders to obtain a plurality of subtraction results. The addition results and the subtraction results may be output 320.

In accordance with an embodiment of the present invention, the method of FIG. 3 may be performed in processor 110 of FIG. 2 in two (2) cycles, where the decoding 305 and selecting 310 a plurality of source operands may occur in a first cycle and the adding/subtracting 315 and outputting 320 may occur in a second cycle. In accordance with other embodiments of the present invention, the method of FIG. 3 also may be performed in one (1) cycle as well as three (3) or more cycles.

In accordance with an embodiment of the present invention, the generalized combined addition/subtraction instruction may be implemented to combine 2 input values into two results. Specifically, the generic syntax of the combined addition/subtraction instruction may be represented by:

[CRR][UCR][acc]destR0, destR1=GADDSUB16(srcA, srcB),

where the square brackets ([ ]) denote the optional instruction parameters that are not required for execution of the instruction; destR0 and destR1 may be destination registers; srcA and srcB may be new data operands; CRR may be a variable that controls the accumulation of condition codes; UCR may be a variable that controls the rotation of OSR 245 and PSR 240; and acc may be a variable that controls whether the results of the instruction execution are accumulated.

Setting the Update Control Register (UCR) variable to TRUE may cause the instruction to rotate the OSR and the PSR 4 bits to the right. Setting CRR to TRUE may cause the instruction to accumulate condition codes into at least one of the CRR registers, for example, in accordance with an embodiment of the present invention, the CRR1 register 235. Similarly, setting acc to TRUE may cause the instruction to accumulate the result of the current cycle with the result of the previous cycle.

In accordance with an embodiment of the present invention, the instructions described below may be, generally, completely executed over two processor clock cycles. However, it should be clearly understood that the instructions also may be implemented to be executed over a single clock cycle as well as over three or more clock cycles. In the following examples, the syntax used may include variables such as signal0′ and signal0″, which are delayed versions of a variable signal by one and two cycles, respectively.

In accordance with an embodiment of the present invention, the functionality of the combined addition/subtraction instruction may be defined by the following C-style pseudo-code example:

First cycle:

| Select Source operands | | |
|---|---|---|
| src0 = {OSR[4i] | ? srcA.h : srcA.1 * {PSR[4i] | ? −1 : 1} |
| src1 = {OSR[4i + 1] | ? srcA.h : srcA.1 * {PSR[4i + 1] | ? −1 : 1} |
| src2 = {OSR[4i + 2] | ? srcB.h : srcB.1 * {PSR[4i + 2] | ? −1 : 1} |
| src3 = {OSR[4i + 3] | ? srcB.h : srcB.1 * {PSR[4i + 3] | ? −1 : 1} |
| if UCR { | | |

Rotate OSR right by 4
Rotate PSR right by 4
}

Second cycle:

Add/Subtract selected operands in pairs and conditionally accumulate
the results if acc {

cout00 & sum00 = CRR1[4i] + src0′ + src2′ + sum00′
sout01 & sum01 = CRR1[4i + 1] + src1′ + src3′ + sum01′
cout10 & sum10 = CRR1[4i + 2] + src0′ − src2′ + sum10′
cout11 & sum11 = CRR1[4i + 3] + src1′ − src3+ + sum11′
} else {
cour00 & sum00 = CRR1[4i] + src0′ + src2′
cout01 & sum01 = CRR1[4i + 1] src1′ + src3′
cout10 & sum10 = CRR1[4i + 2] + src0′ − src2′
cout11 & sum11 = CRR1[4i + 3] + src1′ − src3′
}

if CRR {

| | |
|---|---|
| CRR[4i] | = cout00 |
| CRR1[4i+1] | = cout01 |
| CCR1[4i+2] | = cout10 |
| CRR1[4i+1] | = cout11 |

Shift CRR1 right by 4
}

destR0 = (sum01,sum00)
destR1 = (sum11,sum10)

For example, in one use in accordance with an embodiment of the present invention, if the source operands are interpreted as complex numbers having the format {R, I}, OSR[4i+3, 4i]=1010 and PSR[4i+3, 4i]=0000, then the inputs to the combined addition/subtraction instruction are srcA={R, I} and srcB={R, I}. As a result, destR0={srcAr+srcBr, srcAi+srcBi} and destR1={srcAr-srcbr, srcAi-srcBi}. This illustrates the basic functionality of a combined addition/subtraction instruction.

Similarly, in another use in accordance with an embodiment of the present invention, if OSR[4i+3, 4i]=1001 and PSR[4i+3, 4i]=0001, then the inputs to the combined addition/subtraction instruction are srcA={R, I} and srcB={R, I}. As a result, destR0={srcAr+srcBr, srcAi+srcBi} and destR1={srcAr-srcBr, srcAi+srcBi}. This illustrates how the basic functionality of the combined addition/subtraction instruction can be used, for example, as part of a Radix4 Fast Fourier Transform (FFT) computation.

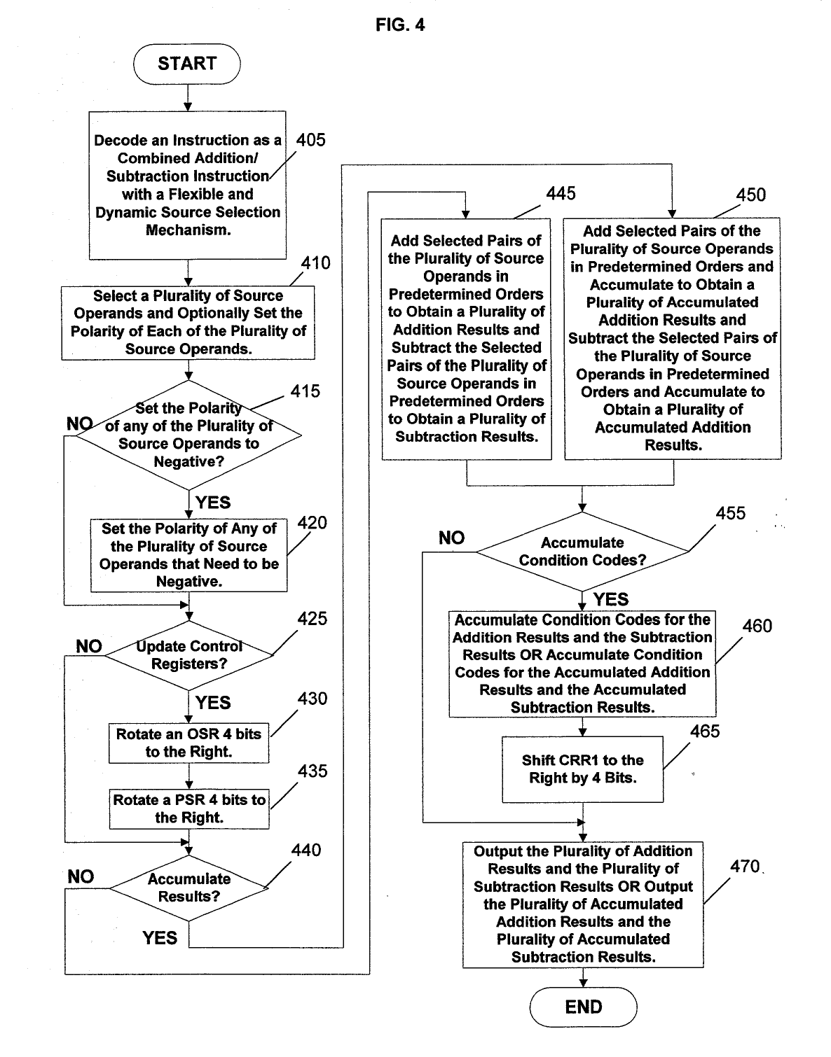

FIG. 4 is a detailed flow diagram of a method for providing a combined addition/subtraction instruction in a processor, in accordance with an embodiment of the present invention. In FIG. 4, an instruction may be decoded 405 in a decoder (not shown) in processor 110 of FIG. 2, as a combined addition/subtraction instruction. In FIG. 4, a plurality of source operands may be selected 410 and the need to set the polarity of one or more of the plurality of source operands may be determined 415. If the polarity needs to be set, the polarity of the one or more plurality of source operands may be set 420.

In FIG. 4, whether the control registers need to be updated may be determined 425. If the control registers need to be updated 425, the OSR may be rotated 430 by 4 bits to the right and the PSR may be rotated 435 by 4 bits to the right.

In FIG. 4, regardless of whether the polarity of source operands was set and/or the control registers were rotated, whether the combined addition/subtraction instruction calls for the results of the instruction to be accumulated may be determined 440. If the results of the combined addition/subtraction instruction are not to be accumulated, selected pairs of the plurality of source operands may be added and subtracted in predetermined orders to obtain a plurality of results 445. In contrast, if the results of the combined addition/subtraction instruction are to be accumulated, selected pairs of the plurality of source operands may be added and subtracted in predetermined orders and accumulated 450 to obtain a plurality of accumulated addition results and a plurality of accumulated subtraction results.

In FIG. 4, if the combined addition/subtraction instruction requires the accumulation of condition codes 455, the condition codes may be accumulated 460 for each of the plurality of addition and subtraction results or the plurality of accumulated addition and subtraction results. For example, in accordance with an embodiment of the present invention, the condition codes may be accumulated in the CRR1 register 235. Following the accumulation 460 of the condition codes, each of the stored condition codes may be shifted to the right by four (4) bits 465.

In FIG. 4, following the addition/subtraction and/or addition/subtraction with accumulation of the results 445, 450, and regardless of whether the condition codes are stored, the plurality of addition and subtraction and/or results the plurality of accumulated addition and subtraction results may be output 470 and the execution of the combined addition/subtraction instruction may terminate.

In accordance with the embodiment of the present invention, a method for providing a combined addition/subtraction instruction includes decoding an instruction as a combined addition/subtraction instruction and selecting a plurality of source operands from the plurality of operands. The method also includes adding selected pairs of the plurality of source operands in predetermined orders to obtain a plurality of addition results and subtracting the selected pairs of said source operands in the predetermined orders to obtain a plurality of subtraction results. The method further includes outputting the plurality of addition results and the plurality of subtraction results.

In accordance with the embodiment of the present invention, a processor including a decoder to decode instructions and a circuit coupled to the decoder. The circuit also, in response to a decoded instruction, to select a plurality of source operands from the plurality of operands; add selected pairs of the plurality of source operands in predetermined orders to obtain a plurality of addition results; subtract the selected pairs of the plurality of source operands in the predetermined orders to obtain a plurality of subtraction results; and output the plurality of addition results and the plurality of subtraction results.

In accordance with an embodiment of the present invention, a computer system including a processor and a machine-readable medium coupled to the processor in which is stored one or more instructions adapted to be executed by the processor. The instructions which, when executed, configure the processor to decode an instruction as a combined addition/subtraction instruction. The combined addition/subtraction instruction configures the processor to select a plurality of source operands from the plurality of operands; add selected pairs of the plurality of source operands in predetermined orders to obtain a plurality of addition results and subtract the selected pairs of the various source operands in the predetermined orders to obtain a plurality of subtraction results; and output the plurality of addition results and the plurality of subtraction results.

In accordance with an embodiment of the present invention, a machine-readable medium in which is stored one or more instructions adapted to be executed by a processor, the instructions which, when executed, configure the processor to decode an instruction as a combined addition/subtraction instruction. The combined addition/subtraction instruction configures the processor to select a plurality of source operands from the plurality of operands; add selected pairs of the plurality of source operands in predetermined orders to obtain a plurality of addition results and subtract the selected pairs of the various source operands in the predetermined orders to obtain a plurality of subtraction results; and output the plurality of addition results and the plurality of subtraction results.

While the embodiments described above relate mainly to 32-bit data path and 32-bit register-based combined addition/subtraction instruction embodiments, they are not intended to limit the scope or coverage of the present invention. In fact, the method described above can be implemented with different sized data types and processing cores such as, but not limited to, for example, 8-bit, 16-bit and/or 32-bit data with 64-bit registers or 8-bit 16-bit, 32-bit and/or 64-bit data with 128-bit registers.

It should, of course, be understood that while the present invention has been described mainly in terms of microprocessor-based and multiple microprocessor-based personal computer systems, those skilled in the art will recognize that the principles of the invention, as discussed herein, may be used advantageously with alternative embodiments involving other integrated processor chips and computer systems. Accordingly, all such implementations, which fall within the spirit and scope of the appended claims, will be embraced by the principles of the present invention.

what is claimed is:

1. A method for providing a combined addition/subtraction instruction in a processor, the method comprising:
decoding an instruction as a combined addition/subtraction instruction;
selecting a plurality of source operands from a plurality of operands, and setting a polarity of each of said plurality of source operands to negative, if a value associated with said source operand is set to require negation of said source operand;
adding selected pairs of said plurality of source operands in predetermined orders to obtain a plurality of addition results and subtracting the selected pairs of said plurality of source operands in the predetermined orders to obtain a plurality of subtraction results; and
outputting said plurality of addition results and said plurality of subtraction results.

2. The method as defined in claim 1 wherein said combined addition/subtraction instruction includes a plurality of destinations and a plurality of operands.

3. The method as defined in claim 1 wherein said selecting operation comprises:
setting a first of said plurality of source operands equal to one of a first plurality of bits from a first of said plurality of operands and a second plurality of bits from said first of said plurality of operands;
setting a second of said plurality of source operands equal to one of said first plurality of bits from said first of said plurality of operands and said second plurality of bits from said first of said plurality of operands;
setting a third of said plurality of source operands equal to one of a first plurality of bits from a second of said plurality of operands and a second plurality of bits from said second of said plurality of operands; and
setting a fourth of said plurality of source operands equal to one of said first plurality of bits from a second of said plurality of operands and a said second plurality of bits from said second of said plurality of operands.

4. The method as defined in claim 3 wherein said setting said first of said plurality of source operands equal to said one of said first plurality of bits from said first of said plurality of operands and said second plurality of bits from said first of said plurality of operands operation comprises:
selecting one of said first plurality of bits and said second plurality of bits from said first of said plurality of operands; and
setting said first source operand equal to said selected one of said first plurality of bits and second said plurality of bits.

5. The method as defined in claim 3 wherein said selecting operation further comprise:
determining a polarity to be set for each of said first, second, third and fourth source operands; and
setting the polarity of each of said first, second, third and fourth source operands based on the determined polarities.

6. The method as defined in claim 1 further comprising:
updating control registers, if requested by said combined addition/subtraction instruction.

7. The method as defined in claim 6 wherein the updating control registers operation comprises:
rotating an operand selection register 4 bits to the right; and
rotating a polarity setting register 4 bits to the right.

8. The method as defined in claim 1 wherein said adding and subtracting operation comprise:
adding a first of said plurality of source operands to a third of said plurality of source operands to obtain a first addition result and, if requested by said combined addition/subtraction instruction, accumulating a prior first addition result with said first addition result, to obtain a first accumulated addition result;
adding a second of said plurality of source operands to a fourth of said plurality of source operands to obtain a second addition result and, if requested by said combined addition/subtraction instruction, accumulating a prior second addition result with said second addition result, to obtain a second accumulated addition result;
subtracting said third of said plurality of source operands from said first of said plurality of source operands to obtain a first subtraction result and, if requested by said combined addition/subtraction instruction, accumulating a prior first subtraction result with said first subtraction result, to obtain a first accumulated subtraction result; and
subtracting said fourth of said plurality of source operands from said second of said plurality of source operands to obtain a second subtraction result and, if requested by said combined addition/subtraction instruction, accumulating a prior second subtraction result with said second subtraction result, to obtain a second accumulated subtraction result.

9. The method as defined in claim 1 further comprising:
rotating an operand selection register four bits to the right; and
rotating a polarity setting register four bits to the right.

10. The method as defined in claim 1 wherein said selecting operation occurs during a first cycle.

11. The method as defined in claim 1 wherein said outputting operation comprises:
storing a first addition result formed by adding a first of said plurality of source operands to a third of said plurality of source operands and a second addition result formed by adding a second of said plurality of source operands with a fourth of said plurality of source operands as a first result; and
storing a first accumulated subtraction result formed by subtracting said third of said plurality of source operands from said first of said plurality of source operands, and a second subtraction result formed by subtracting said fourth of said plurality of source operands from said second of said plurality of source operands.

12. The method as defined in claim 1 wherein said outputting operation comprises:
storing a first accumulated addition result and a second accumulated addition result as a combined accumulated addition result;
storing a first accumulated subtraction result and a second accumulated subtraction result as a combined accumulated subtraction result;
said first accumulated addition result formed by adding a first of said plurality of source operands to a third of said plurality of source operands and to a prior first accumulated addition result;
said second accumulated addition result formed by adding a second of said plurality of source operands to a fourth of said plurality of source operands and to a prior second accumulated addition result;
said first accumulated subtraction result formed by subtracting said third of said plurality of source operands from said first of said plurality of source operands and adding a prior-cycle first accumulated subtraction result; and
said second accumulated subtraction result formed by subtracting said fourth of said plurality of source operands from said second of said plurality of source operands and adding a prior-cycle second accumulated subtraction result.

13. The method as defined in claim 1 further comprising:
accumulating condition codes for said plurality of addition results and said plurality of subtraction results; and
shifting a compare result register 4 bits to the right.

14. The method as defined in claim 13 wherein said accumulating operation and said shifting operation occur only if requested by said combined addition/subtraction instruction.

15. The method of claim 1 wherein said adding and subtracting operation and said outputting operation occur during a second cycle.

16. A processor, said processor comprising:
a decoder to decode instructions; and
a circuit coupled to said decoder, said circuit in response to a decoded instruction to,
select a plurality of source operands from said plurality of operands, and set a polarity of each of said plurality of source operands to negative, if a value associated with said source operand is set to require negation of said source operand;
add selected pairs of said plurality of source operands in predetermined orders to obtain a plurality of addition results and subtract the selected pairs of said plurality of source operands in the predetermined orders to obtain a plurality of subtraction results; and
output said plurality of addition results and said plurality of subtraction results.

17. The processor as defined in claim 16 said circuit further comprising at least one of:
an operand selection register, said operand selection register to control which bits from said plurality of operands are selected for said plurality of source operands;
a polarity setting register, said polarity setting register to conditionally set the polarity of each of said plurality of source operands;
a plurality of compare result registers, said plurality of compare result registers to receive all compare results generated; and
a plurality of 3:1 adders to perform addition and accumulation.

18. The processor as defined in claim 17 wherein the operation of said plurality of 3:1 adders is dynamically controllable at runtime.

19. The processor as defined in claim 17 wherein data generated during the execution of said decoded instruction determines the operation of subsequent instructions.

20. The processor as defined in claim 17 wherein said processor is one of a super-scalar processor and a VLIW processor.

21. A computer system, said computer system comprising:
a processor; and
a machine-readable medium coupled to the processor in which is stored one or more instructions adapted to be executed by the processor, the instructions which, when executed, configure the processor to:
decode an instruction as a combined addition/subtraction instruction;
select a plurality of source operands from said plurality of operands, and set a polarity of each of said plurality of source operands to negative, if a value associated with said source operand is set to require negation of said source operand;
add selected pairs of said plurality of source operands in predetermined orders to obtain a plurality of addition results and subtract the selected pairs of said plurality of source operands in the predetermined orders to obtain a plurality of subtraction results; and
output said plurality of addition results and said plurality of subtraction results.

22. The computer system of claim 21 wherein said processor comprises:
a decoder to decode instructions; and
a circuit coupled to said decoder, said circuit being configured to execute said decoded combined addition/subtraction instruction.

23. The computer system of claim 22 wherein said circuit further comprises at least one of:
an operand selection register, said operand selection register to control which bits from said plurality of operands are selected for said plurality of source operands;
a polarity setting register, said polarity setting register to conditionally set the polarity of each of said plurality of source operands;
a plurality of compare result registers, said plurality of compare result registers to receive all compare results generated; and
a plurality of 3:1 adders to perform addition and accumulation.

24. The computer system of claim 22 wherein said processor is one of a super-scalar processor and a VLIW processor.

25. A machine-readable medium in which is stored one or more instructions adapted to be executed by a processor, the instructions which, when executed, configure the processor to:
decode an instruction as a combined addition/subtraction instruction;
select a plurality of source operands from said plurality of operands, and set a polarity of each of said plurality of source operands to negative, if a value associated with said source operand is set to require negation of said source operand;
add selected pairs of said plurality of source operands in predetermined orders to obtain a plurality of addition results and subtract the selected pairs of said plurality of source operands in the predetermined orders to obtain a plurality of subtraction results; and
output said plurality of addition results and said plurality of subtraction results.

26. The machine-readable medium of claim 25 wherein the instruction which, when executed, further configure the processor to:
set a polarity of each of a plurality of source operands.

27. The machine-readable medium of claim 25 wherein the instruction which, when executed, further configure the processor to:
set a polarity of each of a plurality of source operands during a first cycle.

28. The machine-readable medium of claim 25 wherein said add and subtract operation configures the processor to:
add a first of said plurality of source operands to a third of said plurality of source operands to obtain a first addition result and, if requested by said combined addition/subtraction instruction, accumulate a prior first addition result with said first addition result, to obtain a first accumulated addition result;
add a second of said plurality of source operands to a fourth of said plurality of source operands to obtain a second addition result and, if requested by said combined addition/subtraction instruction, accumulate a prior second addition result with said second addition result, to obtain a second accumulated addition result;
subtract said third of said plurality of source operands from said first of said plurality of source operands to obtain a first subtraction result and, if requested by said combined addition/subtraction instruction, accumulate a prior first subtraction result with said first subtraction result, to obtain a first accumulated subtraction result; and
subtract said fourth of said plurality of source operands from said second of said plurality of source operands to obtain a second subtraction result and, if requested by said combined addition/subtraction instruction, accumulate a prior second subtraction result with said second subtraction result, to obtain a second accumulated subtraction result.

29. The machine-readable medium of claim 25 wherein the instructions which, when executed, further configure the processor to:
rotate an operand selection register four bits to the right; and
rotate a polarity setting register four bits to the right.

30. The machine-readable medium of claim 25 wherein the instructions which, when executed, further configure the processor to:
accumulate condition codes for said plurality of addition results and said plurality of subtraction results; and
shift a compare result register 4 bits to the right.
